(19) United States
(12) Patent Application Publication
(10) Pub. No.: US 2014/0337132 A1
(43) Pub. Date: Nov. 13, 2014

(54) DYNAMIC TEXT REPLACEMENT IN E-BOOKS FOR ADVERTISING

(71) Applicant: YAHOO! INC., Sunnyvale, CA (US)

(72) Inventors: Jonathan Kilroy, Champaign, IL (US); Allie K. Watfa, Urbana, IL (US); Dale Nussel, Mahomet, IL (US); Mangesh Pardeshi, Champaign, IL (US)

(73) Assignee: Yahoo! Inc., Sunnyvale, CA (US)

(21) Appl. No.: 13/888,961

(22) Filed: May 7, 2013

(51) Int. Cl. G06Q 30/02

(52) U.S. Cl. CPC G06Q 30/0251
USPC 705/14.54; 705/14.49; 705/14.53

(57) ABSTRACT

Techniques are provided in which advertisements are presented to a user via access to electronic reading content. A first set of information is obtained regarding electronic reading content evidenced as being accessed by the user. A second set of information is obtained pertaining to a particular user. Using both sets of information, advertising targeting parameters are generated to target the user with one or more advertisements by inserting the advertisements within Based at least in part on the targeting parameters, the user is targeted with at least one advertisement via inserting the advertisement within the electronic reading content.

### BACKGROUND

E-book purchasing has grown dramatically in scale in recent years and continues to grow (where e-books can include electronic books, magazines, newspapers, other forms of electronic reading material, etc.). Yet advertising directed or targeted to e-book readers, and associated monetization techniques, has been less than optimal and has not fully taken advantage of opportunities presented by e-book reading.

There is a need for better techniques for advertising that may be directed to or targeted to e-book readers.

### SUMMARY

Some embodiments of the invention provide techniques that include allowing an advertiser to utilize the content of an e-book as a permissible form of advertising to be presented to the e-book reader via one or more e-books. In some embodiments, the advertising may be targeted based in part on e-book content, which can include content evidenced as being accessed by the e-book reader at a time of advertisement serving.

In some embodiments, techniques are provided in which a first set of information is obtained regarding electronic reading content evidenced as being accessed by a user, such as a page or paragraph being read, for example. A second set of information is obtained relating to user behavior and interests, including social network communications, purchase history, and online search history. Based at least in part on the first two sets of information, advertising targeting parameters are generated and used to target specific users to be presented with advertisements. In some embodiments, techniques are provided in which advertisements are inserted within the electronic reading content such as by replacement of at least portions of the electronic reading content with advertising content.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention; and

FIG. 6 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

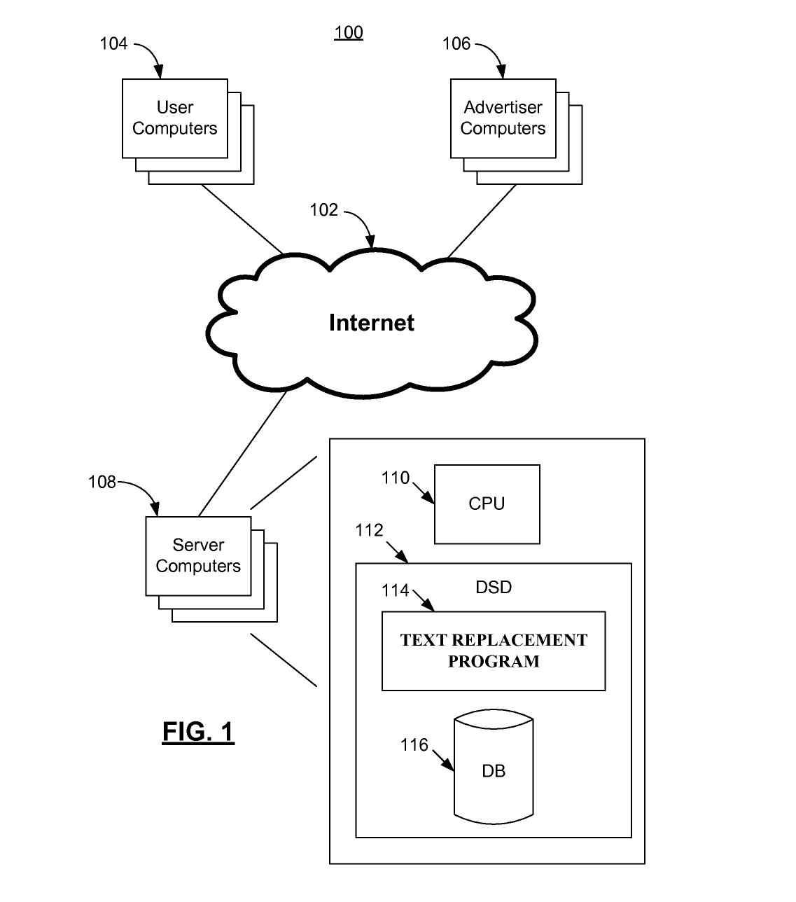

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Text Replacement Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

Various monetization techniques or models may be used in connection with advertising, such as sponsored search advertising, including advertising associated with user search queries, and non-sponsored search advertising, including graphical or display advertising. In an auction-based online advertising marketplace, advertisers may bid in connection with placement of advertisements, although many other factors may also be included in determining advertisement selection or ranking Bids may be associated with amounts the advertisers pay for certain specified occurrences, such as for placed or clicked-on advertisements, for example.

Advertiser payment for online advertising may be divided between parties including one or more publishers or publisher networks, and one or more marketplace facilitators or providers, potentially among other parties. Some models include guaranteed delivery advertising, in which advertisers may pay based on an agreement guaranteeing or providing some measure of assurance that the advertiser will receive a certain agreed upon amount of suitable advertising, and non-guaranteed delivery advertising, which may be individual serving opportunity-based or spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics. In some embodiments of the invention, payment may be based on assessed favorable branding or brand engagement value, for example.

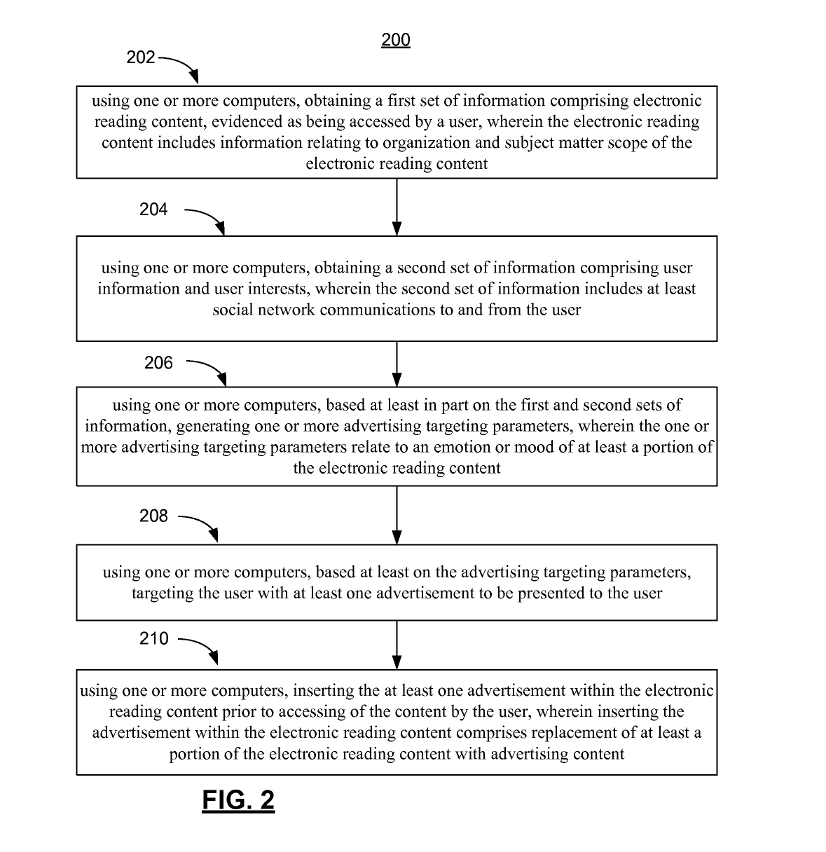

FIG. 2 is a flow diagram illustrating a method 200 according to one embodiment of the invention. At step 202, using one or more computers, a first set of information is obtained, comprising electronic reading content, evidenced as being accessed by a user, wherein the electronic reading content includes information relating to organization and subject matter scope of the electronic reading content.

At step 204, using one or more computers, a second set of information is obtained comprising electronic user information and user interests, wherein the second set of information includes at least social network communications to and from the user.

At step 206, using one or more computers, based at least in part on the first and second sets of information, one or more advertising targeting parameters are generated, wherein the one or more advertising parameters relate to an emotion or mood of at least a portion of the electronic reading content. At step 208, using one or more computers, based at least on the advertising targeting parameters, the user is targeted with at least one advertisement to be presented to the user.

At step 210, using one or more computers, the at least one advertisement is inserted within the electronic reading content prior to being accessed by the user, wherein inserting the advertisement within the electronic reading content comprises replacement of at least a portion of the electronic reading content with advertising content.

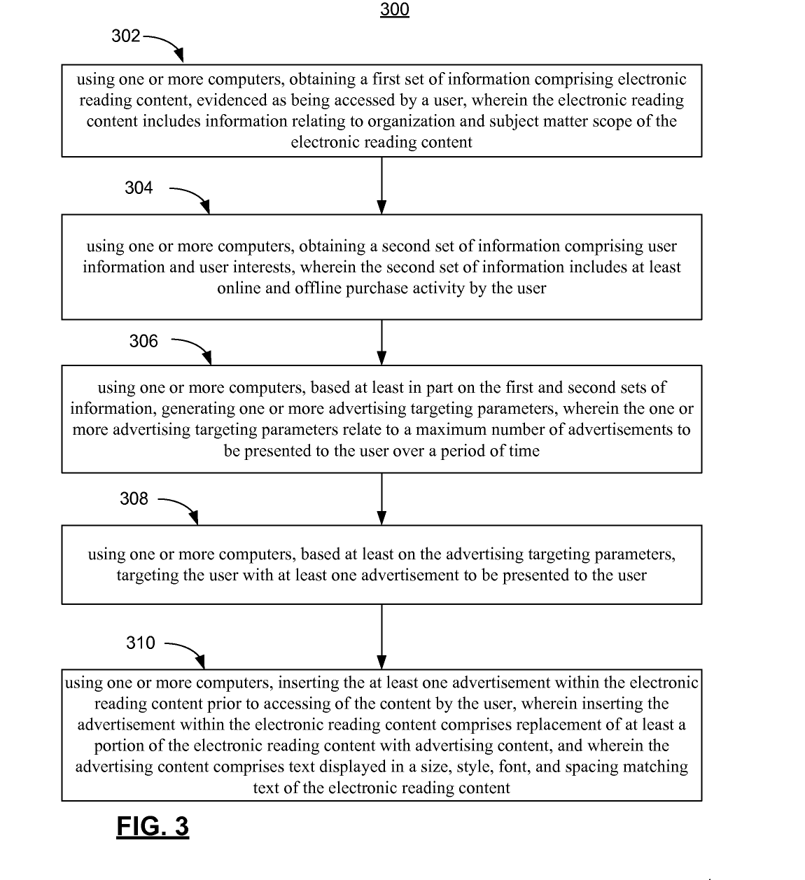

FIG. 3 is a flow diagram illustrating a method 300 according to one embodiment of the invention. At step 302, using one or more computers, a first set of information is obtained, comprising electronic reading content, evidenced as being accessed by a user, wherein the electronic reading content includes information relating to organization and subject matter scope of the electronic reading content.

At step 304, using one or more computers, a second set of information is obtained comprising electronic user information and user interests, wherein the second set of information includes at least online and offline purchase activity by the user. At step 306, using one or more computers, based at least in part on the first and second sets of information, one or more advertising targeting parameters are generated, wherein the one or more advertising targeting parameters relate to a maximum number of advertisements to be presented to the user over a period of time. At step 308, using one or more computers, based at least on the advertising targeting parameters, the user is targeted with at least one advertisement to be presented to the user.

At step 310, using one or more computers, the at least one advertisement is inserted within the electronic reading content prior to being accessed by the user, wherein inserting the advertisement within the electronic reading content comprises replacement of at least a portion of the electronic reading content with advertising content, and wherein the advertising content comprises text displayed in a size, style, font, and spacing matching text of the electronic reading content.

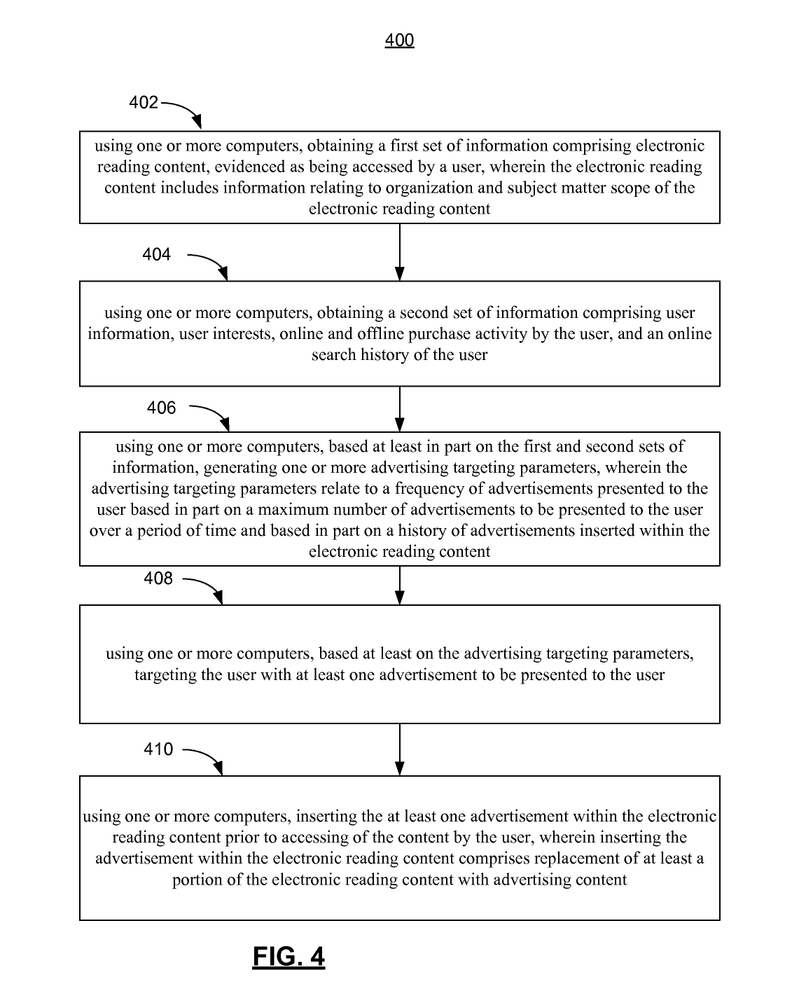

FIG. 4 is a flow diagram illustrating a method 400 according to one embodiment of the invention. At step 402, using one or more computers, a first set of information is obtained, comprising electronic reading content, evidenced as being accessed by a user, wherein the electronic reading content includes information relating to organization and subject matter scope of the electronic reading content.

At step 404, using one or more computers, a second set of information is obtained comprising user information, user interests, online and offline purchase activity by the user, and an online search history of the user. At step 406, using one or more computers, based at least in part on the first and second sets of information, one or more advertising targeting parameters are generated, wherein the advertising targeting parameters relate to a frequency of advertisements presented to the user based in part on a maximum number of advertisements to be presented to the user over a period of time and based in part on a history of advertisements inserted within the electronic reading content. At step 408, using one or more computers, based at least on the advertising targeting parameters, the user is targeted with at least one advertisement to be presented to the user.

At step 410, using one or more computers, the at least one advertisement is inserted within the electronic reading content prior to being accessed by the user, wherein inserting the advertisement within the electronic reading content comprises replacement of at least a portion of the electronic reading content with advertising content.

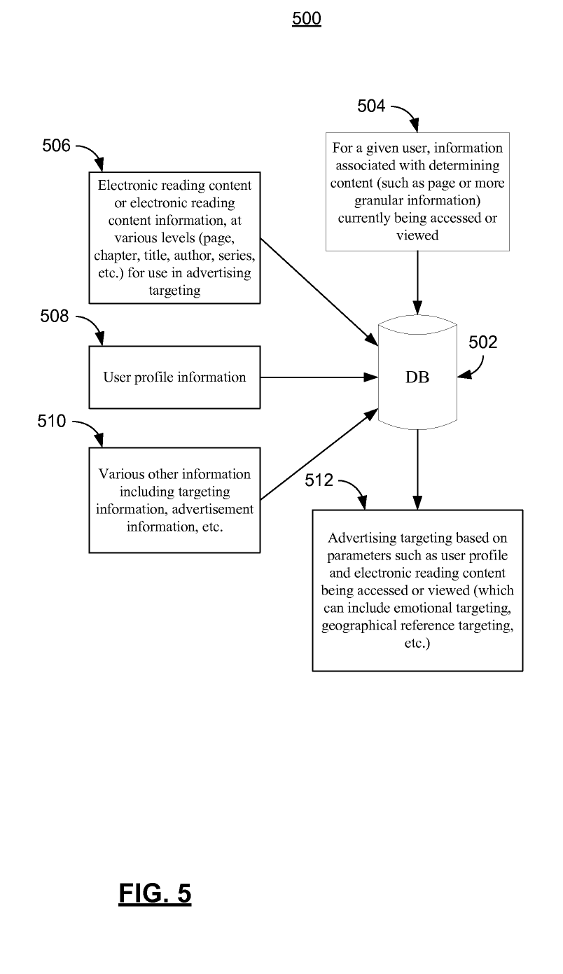

FIG. 5 is a block diagram illustrating one embodiment of the invention. Various types of information are stored in a database 502, including, potentially among other things, electronic reading content and electronic reading content information, at various levels (word or words, term or terms, paragraph, page, chapter, book title, book series, author, etc.) for use in advertising targeting 506, user profile information 508, and various other information including targeting information, advertisement information, etc. 510, as well as, for an user reading the content online, information associated with determining content (such as page or more granular information) currently being accessed or viewed 504.

Block 512 represents advertising targeting based on parameters such as a user profile and electronic reading content being accessed or viewed (which can include emotional targeting, geographical reference targeting, etc.).

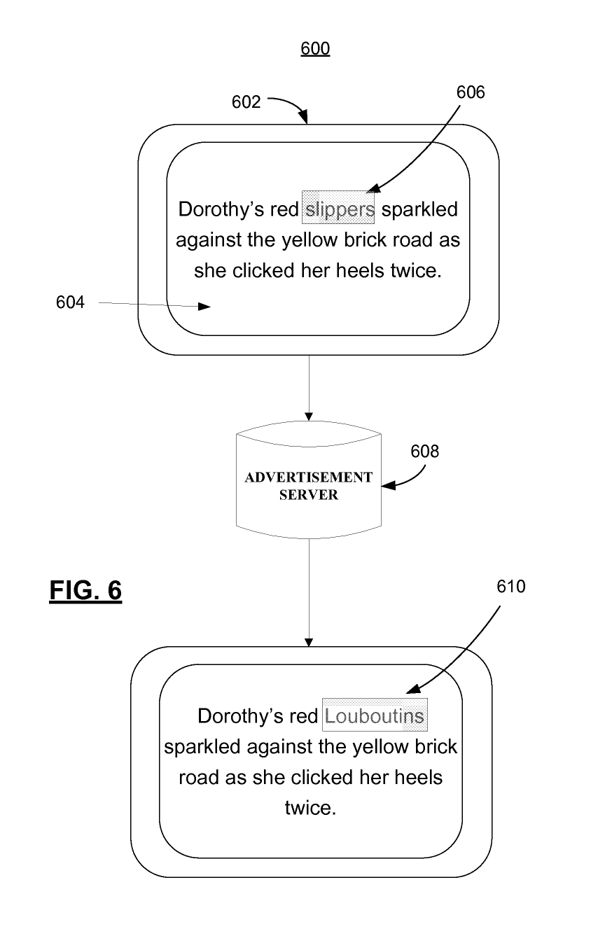

FIG. 6 is a block diagram 600 illustrating one embodiment of the invention. Block 602 is a simplified depiction of electronic reading content, such as a portion of an e-book page, displayed on an e-book reader prior to and after insertion of advertising content.

The graphical display 604 allows a user to view the electronic reading content, such as viewing it on an e-book reader display. Advertising parameters are used by an advertisement server 608 to determine user-targeted content 606 within the electronic reading content and replace the user-targeted content 606 with an inserted advertisement 610. In this example, the word “slippers” are a generic term identified within the electronic reading content as relevant and available to present the user with advertising content. The inserted advertisement 610 replaces at least a portion of the electronic reading content, specifically the user-targeted content 606. In this example, the word “slippers” is replaced with the brand name “Louboutins” based on advertising parameters specific to at least the user and the electronic reading content. In some embodiments, the advertisement is of a permissible type as indicated by a setting selected by the user. In some embodiments, the inserted advertisement 610 can include hyperlinked terms in the text of the user-targeted content 606, where selecting a hyperlinked term may cause the user to be presented with an associated advertisement, or may take the user, if online, to a Web page associated with the hyperlinked term, for example.

In some embodiments, advertising can be based on a mood and setting of content being accessed. For example, if the setting includes young characters, a Coke advertisement could be provided, inviting the user to enjoy a glass of Coke with his or his book, and providing a graphic of a cool glass of Coke, etc.

In some embodiments, advertisements may be inserted prior to viewing electronic reading content, such as being inserted in a static or unchanging fashion prior to downloading of an e-book, for example, such as if the user is reading offline. In some embodiments, advertisements may be inserted in a dynamic fashion, such as online and based on real-time targeting, which can include targeting based on viewing by a user, including a chapter or page being accessed by the user, etc. In some embodiments, hybrid advertising techniques may be utilized, employing both static and dynamic advertising.

In some embodiments, advertising, such as online advertising, is targeted based at least in part on electronic reading content evidenced as being accessed by a user. Being targeted based on content can include, for example, being targeted based on parameters relating to various levels of organization of the book associated with accessed content, including, for example, a word, words, term, sentence, paragraph, chapter, or even book or book or book title (even though obviously an entire chapter may not be being accessed, but rather content within the chapter, for example). Targeting can also be based on higher level or less directly associated parameters, such as book author, book series, etc.

Any of various techniques or combinations of techniques can be used in embodiments of the invention in determining (whether for certain or with any of various levels of confidence or certainty), estimating or guessing what content is being accessed or is likely to be being accessed. In some embodiments, forecasting and predicting may be utilized, including factors relating to the content as well as potentially the user or the user's behavior, such as the reader's rate of reading, scrolling information etc. Utilized information could include zooming-in or other viewing tools used by the user. Furthermore, in some embodiments, machine learning or other sophisticated techniques could be employed in making determinations or predictions. In some embodiments, it may be straightforward to determine a page of the content being accessed by an online user at a given time, for instance. In some embodiments, it may be possible to determine or guess, with varying degrees of confidence, at more granular levels, such as down to a sentence or even term or word being accessed or read.

Some embodiments of the invention include targeting that takes advantage of accessed content targeting at several different levels of organization with regard to the content. For example, targeting could be based on a topic or mood associated with the title of the book as well as a topic or mood associated with content at a more granular level, such as the particular chapter, or even paragraph or sentence, for example. In some embodiments, a combination of such parameters is utilized, which may be more effective than targeting based on each individually. As just one illustrative example, if a book title relates to wineries, and a particular chapter relates to a particular area of California, then advertising could relate to a winery in that area of California, etc.

Some embodiments take advantage of or include use of social networking information, such as such explicit or implicit social networking information associated with the user. For example, some targeting parameters could relate to others a social network of the user, or associated interests, trending, etc. Furthermore, implicit social networks could be identified for this purpose, such as by determining users that also purchased or read the content that the user is reading, or users that read similar books or books by the same author, or publisher, for example. In some embodiments, advertisers can provide criteria relating to such.

In some embodiments, targeting parameters can include not only targeting based on a geographic location of the user, or setting of the e-book, for example, but could also be more broadly or additionally based on geographic or location references in the electronic reading content itself

In some embodiments, emotional or mood-based targeting is utilized, such as by taking into account an emotional state or situation associated with content being accessed, etc.

In some embodiments, targeting may take into account specific item or situational references in content being accessed, which could include sensory or sense-associated references. For example if content being accessed includes a character enjoying a relaxing cup of hot tea, advertisements could be provided relating to that item, or relaxing drinks or other comfort food products, etc.

In some embodiments, targeting parameters may be based at least in part on user profiles, which can include any of various aspects, including emotional or other profile aspects. Profiles can be constructed using information regarding user choices, tagging, preferences, choices, etc.

In some embodiments, advertising can take advantage of aspects of accessed content that may include human senses and sensations that the author is attempting to convey. An example of this might relate to, from the book, “Polar Express”, the passage, “. . . as the kids got seated, the waiter started to serve refreshing hot cocoa as thick and rich as melted chocolate bars . . . .” This may be an excellent opportunity to show an advertisement for hot cocoa or a Hersey's chocolate bar, as the user has already been acclimated or positively predisposed by the story he or she is immersed in.

In some embodiments, keywords (which can be words or terms of the content, or associated with an e-book or portions thereof, etc.) and tags are utilized, and categories of such, and detected patterns and can trigger advertising associated with the keywords and tags, etc. For example, if keywords or tags relate to love or affection, advertisements can be provided that relate to flowers, food or entertainment, for example.

Furthermore, in some embodiments, a progression over multiple chapters or subjects show that there is a certain mood and tone that falls under a particular category, such as vacations, for example, then the system may detect this pattern and match advertising to the context, such as advertising relating to a vacation offer. As such, some embodiments include using moods and emotions associated with the book in addition to a detected context to trigger advertising that is relevant to both. Furthermore, historical information regarding activities of the user, such as previous content read by the user, can be used to further guide and enrich targeting. For example, if the historical information indicates an inclination toward or preference for a particular mood, situation, or topic, or even specific likes such as movies, for instance, then this can be used in targeting or filtering of advertising.

While the invention is described with reference to the above drawings, the drawings are intended to be illustrative, and the invention contemplates other embodiments within the spirit of the invention.

1. A method comprising:
using one or more computers, obtaining a first set of information comprising electronic reading content, evidenced as being accessed by a user, wherein the electronic reading content includes information relating to organization and subject matter scope of the electronic reading content;
using one or more computers, obtaining a second set of information comprising user information and user interests;
using one or more computers, based at least in part on the first and second sets of information, generating one or more advertising targeting parameters;
using one or more computers, based at least on the advertising targeting parameters, targeting the user with at least one advertisement to be presented to the user; and
using one or more computers, inserting the at least one advertisement within the electronic reading content prior to accessing of the content by the user, wherein inserting the at least one advertisement comprises replacement of at least a portion of the electronic reading content with advertising content.

2. The method of claim 1, wherein the second set of information includes at least social network communications to and from the user.

3. The method of claim 1, wherein the second set of information includes at least online and offline purchase activity by the user.

4. The method of claim 1, wherein the second set of information includes at least an online search history of the user.

5. The method of claim 1, wherein the advertising content comprises text displayed in a size, style, font, and spacing matching text of the electronic reading content.

6. The method of claim 1, wherein the advertising content comprises at least a hyperlink.

7. The method of claim 1, wherein the one or more advertising targeting parameters relate to a maximum number of advertisements to be presented to the user over a period of time.

8. The method of claim 7, wherein the one or more advertising targeting parameters relate to a frequency of advertisements presented to the user based in part on the maximum number of advertisements to be presented to the user over a period of time.

9. The method of claim 1, wherein the one or more advertising targeting parameters relate to a history of advertisements inserted within the electronic reading content.

10. The method of claim 1, wherein the one or more advertising targeting parameters relate to an emotion or mood of at least a portion of the electronic reading content.

11. A system comprising:
one or more server computers coupled to a network; and
one or more databases coupled to the one or more server computers;
wherein the one or more server computers are for:
obtaining a first set of information comprising electronic reading content, evidenced as being accessed by a user, wherein the electronic reading content includes information relating to organization and subject matter scope of the electronic reading content;
obtaining a second set of information comprising user information and user interests;
based at least in part on the first and second sets of information, generating one or more advertising targeting parameters;
based at least on the advertising targeting parameters, targeting the user with at least one advertisement to be presented to the user; and
inserting the at least one advertisement within the electronic reading content prior to accessing of the content by the user, wherein inserting the at least one advertisement comprises replacement of at least a portion of the electronic reading content with advertising content.

13. The system of claim 11, wherein the second set of information includes at least social network communications to and from the user.

14. The system of claim 11, wherein the second set of information includes at least online and offline purchase activity by the user.

15. The system of claim 11, wherein the advertising content comprises text displayed in a size, style, font, and spacing matching text of the electronic reading content.

16. The system of claim 15, wherein the advertising content comprises at least a hyperlink.

17. The system of claim 11, wherein the one or more advertising targeting parameters relate to a maximum number of advertisements to be presented to the user over a period of time.

18. The system of claim 17, wherein the one or more advertising targeting parameters relate to a frequency of advertisements presented to the user based in part on the maximum number of advertisements to be presented to the user over a period of time.

19. The system of claim 11, wherein the one or more advertising targeting parameters relate to a history of advertisements inserted within the electronic reading content.

20. A computer readable medium or media containing instructions for executing a method, the method comprising:
using one or more computers, obtaining a first set of information comprising electronic reading content, evidenced as being accessed by a user, wherein the electronic reading content includes information relating to organization and subject matter scope of the electronic reading content;
using one or more computers, obtaining a second set of information comprising user information, user interests, online and offline purchase activity by the user, and an online search history of the user;
using one or more computers, based at least in part on the first and second sets of information, generating one or more advertising targeting parameters, wherein the advertising targeting parameters relate to a frequency of advertisements presented to the user based in part on a maximum number of advertisements to be presented to the user over a period of time and based in part on a history of advertisements inserted within the electronic reading content;
using one or more computers, based at least on the advertising targeting parameters, targeting the user with at least one advertisement to be presented to the user; and
using one or more computers, inserting the at least one advertisement within the electronic reading content prior to accessing of the content by the user, wherein inserting the at least one advertisement comprises replacement of at least a portion of the electronic reading content with advertising content.
